(19) United States
(12) Patent Application Publication
(10) Pub. No.: US 2004/0041846 A1
(43) Pub. Date: Mar. 4, 2004

(54) System and method for visualizing data

(76) Inventors: Peter Hurley, Hollis, NH (US); Andrew Najda, Carlisle, MA (US); Joseph J. Cobau, Melrose, MA (US); Steven C. Fried, Lexington, MA (US)

Correspondence Address: Mark J. Pandiscio, Pandiscio & Pandiscio, P.C., 470 Totten Pond Road, Waltham, MA, 02451-1914, US

(21) Appl. No.: 10/411,430

(22) Filed: Apr. 10, 2003

Related U.S. Application Data
(60) Provisional application No. 60/371,466, filed on Apr. 10, 2002.

(51) Int. Cl. G09G 5/00

(52) U.S. Cl. 345/848

(57) ABSTRACT

A data visualization system for visualizing data comprising at least one data set, wherein the data visualization system comprises: user controls for permitting a user to supply instructions to the data visualization system; a model database comprising a plurality of virtual three dimensional models; and a processing engine adapted to receive user instructions provided through the user controls and, in accordance with those instructions, (1) select a virtual three dimensional model from a plurality of three dimensional virtual models contained in the model database, (2) access the at least one data set, and (3) populate the selected virtual three dimensional model with the accessed at least one data set, whereby to generate a data structure comprising the selected virtual three dimensional model embodying a specific instance of the accessed at least one data set; whereby the data structure can be used as an input to an image rendering engine so as to generate a two dimensional image for display to the user. In another form of the invention, there is provided a method for visualizing data comprising at least one data set, wherein the method comprises: selecting a virtual three dimensional model from a plurality of three dimensional models contained in a model database; accessing the at least one data set; populating the selected virtual three dimensional model with the accessed at least one data set, whereby to generate a data structure comprising the selected virtual three dimensional model embodying a specific instance of the accessed at least one data set; and inputting the data structure to an image rendering engine so as to generate a two dimensional image for display to the user.

### REFERENCE TO PENDING PRIOR PATENT APPLICATION

This patent application claims benefit of pending prior U.S. Provisional Patent Application Serial No. 60/371,466, filed Apr. 10, 2002 by Peter Hurley et al. for XD IMAGINE XD (Attorney's Docket No. IMAG-1 PROV), which patent application is hereby incorporated herein by reference.

### FIELD OF THE INVENTION

This invention relates to data visualization in general, and more particularly to systems and methods for visualizing data, and even more particularly to systems and methods for visualizing financial data.

### BACKGROUND OF THE INVENTION

A large number of investors are now trading in the securities markets. According to Business Week™, there are currently about 100 million individual investors in the United States alone. These individuals invest in the securities markets either on their own as individual traders or through a variety of brokers. According to The Tower Group™, there are currently about 675,000 registered brokers in the United States alone. These brokers work at about 5,500 different firms which staff almost 90,000 branch offices throughout the United States.

An enormous amount of financial information is now available to professional and individual investors, and the volume and availability of this information is growing at an explosive rate. By way of example, note the recent explosion of online financial information. Price quotes for almost any financial instrument (e.g., stocks, bonds, etc.) are now readily available from a wide variety of online sites. Furthermore, Morningstar™ now offers its mutual fund ratings online, and Yahoo™ allows an investor to review SEC filings, look at analysts' stock recommendations, and learn how other markets around the world are performing. At the same time, traditional print publications such as The Wall Street Journal™ and The Financial Times™ are making more and more financial information available to the reader, and traditional broadcast media such as television and cable television are now providing 24-hour business programming.

The widespread availability of this enormous volume of often conflicting and confusing information often inhibits the ability of investors to comprehend and utilize the information efficiently. As a result, their confidence in what that information means frequently decreases almost in proportion to the rate at which the quantity of information grows. The sheer quantity of data obscures the correlation and interdependencies inherent in that data. For individual investors, the volume of data can be daunting. Even experienced traders, looking at dynamically changing assortments of numbers, tables, charts and graphs, are sometimes overwhelmed. This often leads to increased stress, eye fatigue and frustration. Under these conditions, even seasoned professionals sometimes fail to make critical decisions well and frequently resort to the oldest—and possibly the most unreliable—criteria of all, the “gut instinct”.

Thus there is a significant need for a more effective tool for mining the wealth of financial data currently available, extracting significant information therefrom, and presenting the same to the investor in a visually compelling manner.

### SUMMARY OF THE INVENTION

The present invention comprises an improved system and method for visualizing data. In a preferred form of the invention, there is provided an improved system and method for comprehending and communicating financial data, and their complex interdependencies, through the use of a novel three dimensional orthogonal chart system.

In one form of the invention, there is provided a data visualization system for visualizing data comprising at least one data set, wherein the data visualization system comprises: user controls for permitting a user to supply instructions to the data visualization system; a model database comprising a plurality of virtual three dimensional models; and a processing engine adapted to receive user instructions provided through the user controls and, in accordance with those instructions, (1) select a virtual three dimensional model contained in the model database, (2) access the at least one data set, and (3) populate the selected virtual three dimensional model with the accessed at least one data set, whereby to generate a data structure comprising the selected virtual three dimensional model embodying a specific instance of the accessed at least one data set; whereby the data structure can be used as an input to an image rendering engine so as to generate a two dimensional image for display to the user.

In another form of the invention, there is provided a method for visualizing data comprising at least one data set, wherein the method comprises: selecting a virtual three dimensional model from a plurality of three dimensional models contained in a model database; accessing the at least one data set; populating the selected virtual three dimensional model with the accessed at least one data set, whereby to generate a data structure comprising the selected virtual three dimensional model embodying a specific instance of the accessed at least one data set; and inputting the data structure to an image rendering engine so as to generate a two dimensional image for display to the user.

In another preferred form of the invention, there is provided a three dimensional orthogonal chart system for visualizing data comprising at least two data sets, wherein one data set is represented as a ribbon propagating along a first axis and the second data set is represented as a curtain propagating along the first axis.

In another preferred form of the invention, there is provided a three dimensional orthogonal chart system for visualizing data comprising at least three data sets, wherein one data set is represented as a ribbon propagating along a first axis, the second data set is represented as a curtain propagating along the first axis, and the third data set is represented as a back plane propagating along the first axis.

In another preferred form of the invention, there is provided a three dimensional orthogonal chart system for visualizing data comprising at least three data sets, wherein one data set is represented as a ribbon propagating along a first axis, the second data set is represented as a first curtain propagating along the first axis, and the third data set is represented as a stacked curtain propagating along the first axis.

In another preferred form of the invention, there is provided a three dimensional orthogonal chart system for visualizing data comprising at least four data sets, wherein one data set is represented as a ribbon propagating along a first axis, the second and third data sets are represented as first and second stacked curtains propagating along the first axis, and the fourth data set is represented as a back plane propagating along the first axis, wherein the fourth data set may comprise a composite of the second and third data sets.

In another preferred form of the invention, there is provided a three dimensional orthogonal chart system for visualizing data comprising a plurality of data sets, wherein each of the data sets is represented as a separate ribbon propagating along a first axis, with the separate ribbons being displaced from one another along another axis.

In another preferred form of the invention, there is provided a three dimensional orthogonal chart system for visualizing data comprising a plurality of data sets, wherein each of the data sets is represented as a separate ribbon propagating along a first axis, with the separate ribbons being displaced from one another along another axis, and further wherein a moving cursor plane is configured for movement along the first axis.

In another preferred form of the invention, there is provided a three dimensional orthogonal chart system for visualizing data comprising a plurality of data sets, wherein each of the data sets is represented as a separate ribbon propagating along a first axis, with the separate ribbons being displaced from one another along a second axis, and with the angle of view being an overhead view in an orthographic projection.

In another preferred form of the invention, there is provided a three dimensional orthogonal chart system for visualizing data comprising the pricing, distribution, and trading activity for option contracts, including both calls and puts, with strike price being plotted along the first axis, option price (or some other data set) being plotted along the second axis, and expiration date being plotted along a third axis.

### BRIEF DESCRIPTION OF THE DRAWINGS

These and other objects and features of the present invention will be more fully disclosed or rendered obvious by the following detailed description of the preferred embodiments of the invention, which is to be considered together with the accompanying drawings wherein like numbers refer to like parts and further wherein:

FIG. 1 is a schematic view showing the system architecture for one preferred form of the present invention;

FIG. 2 is a schematic view showing a first exemplary illustration of the present invention, wherein there is provided a three dimensional orthogonal chart system for visualizing data comprising at least two data sets, wherein one data set is represented as a ribbon propagating along a first axis and the second data set is represented as a curtain propagating along the first axis;

FIG. 3 is a schematic view showing a second exemplary illustration of the present invention, wherein there is provided a three dimensional orthogonal chart system for visualizing data comprising at least three data sets, wherein one data set is represented as a ribbon propagating along a first axis, the second data set is represented as a curtain propagating along the first axis, and the third data set is represented as a back plane propagating along the first axis;

FIG. 4 is a schematic view showing a third exemplary illustration of the present invention, wherein there is provided a three dimensional orthogonal chart system for visualizing data comprising at least four data sets, wherein one data set is represented as a ribbon propagating along a first axis, the second data set is represented as a first curtain propagating along the first axis, and the third and fourth data sets are represented as stacked curtains propagating along the first axis;

FIG. 5 is a schematic view showing a fourth exemplary illustration of the present invention, wherein there is provided a three dimensional orthogonal chart system for visualizing data comprising at least four data sets, wherein one data set is represented as a ribbon propagating along a first axis, the second and third data sets are represented as first and second stacked curtains propagating along the first axis, and the fourth data set is represented as a back plane propagating along the first axis, wherein the fourth data set comprises a composite of the second and third data sets;

FIG. 6 is a schematic view showing a fifth exemplary illustration of the present invention, wherein there is provided a three dimensional orthogonal chart system for visualizing data comprising a plurality of data sets, wherein each of the data sets is represented as a separate ribbon propagating along a first axis, with the separate ribbons being displaced from one another along another axis;

FIG. 7 is a schematic view showing a sixth exemplary illustration of the present invention, wherein there is provided a three dimensional orthogonal chart system for visualizing data comprising a plurality of data sets, wherein each of the data sets is represented as a separate ribbon propagating along a first axis, with the separate ribbons being displaced from one another along another axis, and further wherein a moving cursor plane is configured for movement along the first axis;

FIG. 8 is a schematic view showing a seventh exemplary illustration of the present invention, wherein there is provided a three dimensional orthogonal chart system for visualizing data comprising a plurality of data sets, wherein each of the data sets is represented as a separate ribbon propagating along a first axis, with the separate ribbons being displaced from one another along a second axis, and with the angle of view being an overhead view in an orthographic projection; and

FIG. 9 is a schematic view showing an eighth exemplary illustration of the present invention, wherein there is provided a three dimensional orthogonal chart system for visualizing data comprising the pricing, distribution, and trading activity for option contracts, including both calls and puts, with strike price being plotted along the first axis, option price (or some other data set) being plotted along the second axis, and expiration date being plotted along a third axis.

### DETAILED DESCRIPTION OF THE PREFERRED EMBODIMENTS

Overview

The present invention provides a unique system and method for visualizing financial information.

More particularly, the present invention provides a unique visualization system for visualizing financial information relating to securities and other financial instruments such as, but not limited to, stocks, bonds, mutual funds, options, futures, indexes, derivatives, currency, Treasuries, money market funds and the like.

The financial information being visualized may be based on raw data obtained from a historical database and/or a live data feed, and/or it may be based on data derived from (e.g., calculated from) a historical database and/or a live data feed.

In order to create the desired visualization for the financial information, the axes of a three dimensional orthogonal coordinate system are first established based on attributes of the data. These attributes may be, but are not limited to, time, price, volume, yield, relative compound growth, relative portfolio value and/or other relevant metrics. The axes may be linear or non-linear, continuous or non-continuous (i.e., discrete), and/or contiguous or non-contiguous, as desired. For example, multiple, discrete date ranges of a single security may be displayed simultaneously within the same visualization. By way of further example but not limitation, an axis may represent a finite, discrete domain, e.g., the strike prices of option contracts.

The data is then plotted into the chart in accordance with the present invention.

Data Visualization System

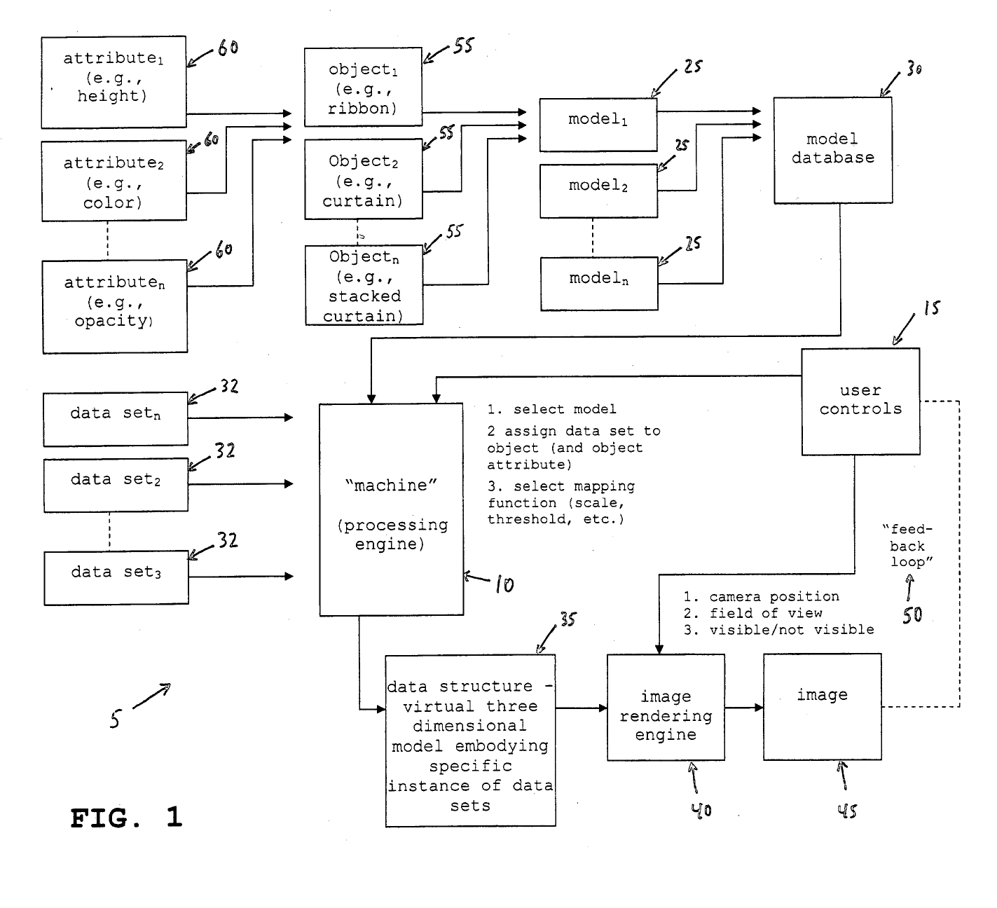

Looking first at FIG. 1, there is shown a data visualization system 5 for visualizing data, e.g., financial information. Data visualization system 5 generally comprises a processing engine 10 adapted to receive user instructions provided through user controls 15 and, in accordance with those instructions, (1) select a virtual three dimensional model 25 from a plurality of three dimensional virtual models contained in a model database 30, (2) access one or more data sets 32, and (3) populate the selected virtual three dimensional model 25 with the accessed one or more data sets 32, whereby to generate a data structure 35 comprising the selected virtual three dimensional model 25 embodying a specific instance of the accessed one or more data sets 32. Data structure 35 is then used as an input to an image rendering engine 40 which, in accordance with user instructions provided through user controls 15, generates a two dimensional image 45 for display to the user, e.g., on a computer monitor. Based upon this two dimensional image 45, the user can then use feedback loop 50 to adjust the aforementioned model selection, and/or the aforementioned data set accessing, and/or the aforementioned data population, and/or the aforementioned image rendering instructions, so as to modify the image 45 produced by the system, whereby to render selected aspects of the accessed data sets more visually apparent to a viewer.

Processing engine 10 may comprise application software running on a general purpose computer. The application software is adapted to provide the functionality as described in this document.

User controls 15 may comprise various user interface controls for operating the general purpose computer running the application software of processing engine 10. By way of example but not limitation, user controls 15 may comprise human interface devices such as a keyboard, a mouse, a touch screen display, a trackball, voice recognition software, etc., and user controls 15 may comprise various software controls such as buttons, check boxes, menus, list boxes, text entry fields, dialogs, etc. In one preferred form of the invention, software controls are exposed to the user on the basis of the specific object 55 selected, i.e., once a specific object 55 is selected, appropriate software controls for that specific object are exposed to the user.

Each of the virtual three dimensional models 25 contained in database 30 comprises a plurality of virtual three dimensional objects 55 arranged relative to one another in a three dimensional orthogonal coordinate system. Objects 55 may comprise various three dimensional shapes including, but not limited to, ribbons, curtains, stacked curtains, back planes, moving cursor planes, rectangular blocks, cylinders, etc. Each of these objects, according to its particular character, generally has one or more attributes 60 associated therewith. Attributes 60 may reflect various physical properties of an object 55 including, but not limited to, height, width, depth, color, opacity, material properties (e.g., texture, reflectivity, shininess, etc.), etc.

Model database 30 comprises a plurality of the aforementioned virtual three dimensional models 25. Preferably each of the models 25 contained in model database 30 provides a different combination of objects 55, whereby the user can select a particular model 25 for use in presenting particular data sets 32. By way of example but not limitation, where stock price and volume is to be displayed to the viewer, the user might utilize user controls 15 to select a particular model 25 having a ribbon object 55 and a curtain object 55, and then map price to the height attribute 60 of ribbon object 55 and map volume to the width attribute 60 of curtain object 55.

Data sets 32 comprise data of interest to the user, e.g., they may comprise financial information. Data sets 32 may be based upon raw data obtained from a historical database and/or a live data feed, and/or data sets 32 may be based upon data derived from (e.g., calculated from) a historical database or a live data feed. By way of example but not limitation, data sets 32 may comprise price, volume, yield, relative compound growth, relative portfolio value, and/or other relevant metrics relating to securities and other financial instruments such as, but not limited to, stocks, bonds, mutual funds, options, futures, indexes, derivatives, currency, Treasuries, money market funds, and the like. Some data sets 32 may be obtained directly from their source, e.g., a vendor of financial information, a private corporate database, a spreadsheet running on the aforementioned general purpose computer, etc. Additionally, processing engine 10 may be adapted to derive additional data sets 32 from the aforementioned source data sets. By way of example but not limitation, where a source data set provides price information, processing engine 10 may be adapted to derive statistical data sets relating to variance from norm, moving average, moving standard deviation, etc. In one preferred form of the invention, processing engine 10 is configured to provide a suite of processing functions for generating derived data sets, with the user utilizing user controls 15 to select specific processing functions, and the parameters relating thereto (e.g., the sample window for a moving average), whereby to generate the desired data sets.

Data structure 35 may comprise any data structure capable of representing the selected virtual three dimensional model 25 embodying a specific instance of the accessed data sets 32. By way of example but not limitation, data structure 35 may comprise a polygonal surface model.

Image rendering engine 40 may comprise any application software (e.g., running on the aforementioned general purpose computer) capable of receiving data structure 35 and rendering a two dimensional image 45 therefrom. By way of example but not limitation, where data structure 35 comprises a polygonal surface model, image rendering engine 40 may comprise the Virtual Rendering System (VRS) available from www.vrs3d.org.

In accordance with the present invention, the user utilizes user controls 15 to select a particular virtual three dimensional model 25 from model database 30. This may be done, for example, with a pull-down menu. Thus, by way of example but not limitation, the user might select a particular model 25 having a ribbon object 55 and a curtain object 55. The user then utilizes user controls 15 to assign a particular data set 32 (which may be a source data set or which may be a derived data set, in which case user controls 15 may be utilized to specify the derived data set, as discussed above) to a particular object 55 and, more particularly, to a particular attribute 60 of that object. Thus, by way of example but not limitation, the user might assign the price of a particular stock to the height attribute 60 of the ribbon object 55, and the user might assign the volume of a particular stock to the width attribute 60 of the curtain object 55. The user also utilizes user controls 15 to select the particular mapping function associated with this data assignment, i.e., the mapping parameters used to map the selected data set to the selected object attribute. By way of example but not limitation, the user might utilize user controls 15 to adjust the mapping function to a particular scale or visibility threshold, e.g., when mapping price to the height attribute 60 of a ribbon object 55, or when mapping volume to the width attribute 60 of a curtain object 55, or when shading a surface of an object, etc. It should be appreciated that in one preferred form of the invention, the system is configured to permit each object 55 to be accessed (i.e., selected) independently of every other object 55 and, for a given object 55, for each attribute 60 to be accessed independently of every other attribute 60 of that object.

Processing engine 10 then generates a data structure 35 comprising a virtual three dimensional model 25 embodying a specific instance of the accessed data sets 32. This data structure 35 is then used as an input to image rendering engine 40 which, in accordance with user instructions provided by user controls 15 (e.g., camera position, field of view, object X “not visible”, i.e., rendered transparent, etc.) then generates the two dimensional image 45. The user may then view the two dimensional image 45 (e.g., on a monitor of the aforementioned general purpose computer). If desired, the user may then use feedback loop 50 to modify any of the previously selected parameters of the system (e.g., the particular model selected, the particular data set assigned to an object attribute, the particular mapping function selected, the camera position, etc.) so as to render one or more aspects of the data more visually apparent to the viewer when viewing the two dimensional image 45.

It should also be appreciated that in many circumstances, the accessed data sets 32 may not be static, i.e., they may be dynamic in the sense that their data is changing. By way of example but not limitation, the accessed data sets 32 may relate to stock prices which are changing during trading sessions. On account of the foregoing, in one preferred form of the invention, processing engine 10 is configured to respond to changes in data sets 32 by regenerating data structure 35, which is then further processed by image rendering engine 40 so as to render a new two dimensional image 45. In one preferred form of the invention, processing engine 10 is configured to monitor data sets 32 and respond to changes in the data sets by regenerating data structure 35; however, in another preferred form of the invention, processing engine 10 is configured to periodically re-access data sets 32 and automatically regenerate data structure 35.

It should also be appreciated that with data visualization system 5, the user selects a model 25 from model database 30; inasmuch as this model contains a specific set of objects 55, and each of these objects is in turn characterized by a specific set of attributes 60, the selection of a specific model 25 from model database 30 yields a finite number of mapping locations for data sets 32. This is significant, inasmuch as it reflects a unique manner of looking at data visualization, in the sense that it is model-focused rather than data-focused.

First Exemplary Illustration

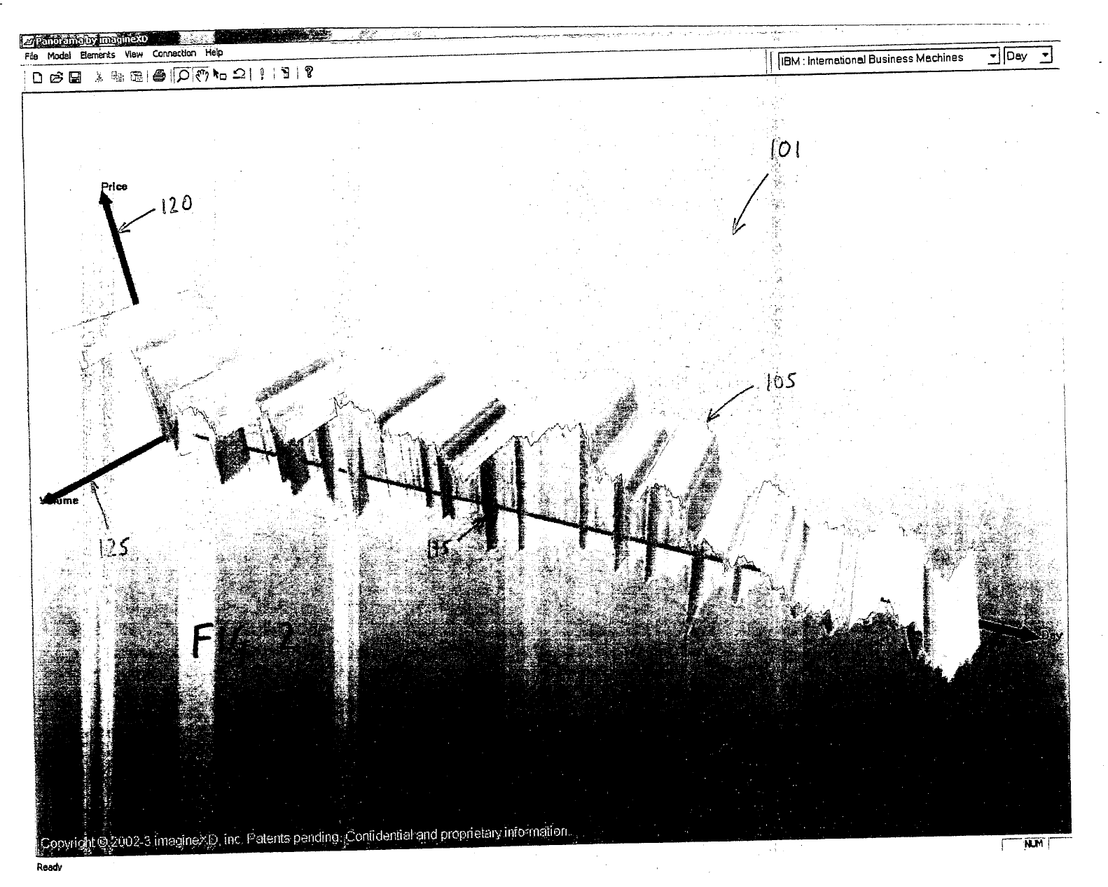

Looking next at FIG. 2, in one preferred exemplary illustration of the present invention, there is provided a three dimensional orthogonal chart system 101 for visualizing data comprising at least two data sets, wherein one data set is represented as a ribbon 105 propagating along a first (i.e., X) axis 110, and the second data set is represented as a curtain 115 propagating along the first axis 110. Preferably ribbon 105 varies in height along a second (i.e., Y) axis 120, while having a substantially fixed width as measured along the third axis (i.e., Z) axis 125. Preferably curtain 115 has a height along the second (Y) axis 120 which is the same as the height of ribbon 105 at that point along the first (X) axis 110, and a varying displacement along the third (Z) axis 125. Alternatively, curtain 115 may have a height different than the height of ribbon 105, e.g., it may be of a fixed height intersecting ribbon 105. If desired, ribbon 105 and/or curtain 115 can be colored and/or variably shaded and/or of varying opacity and/or of varying material properties (e.g., texture, reflectivity, shininess, etc.) so as to communicate additional information (i.e., data sets). In one particularly preferred form of the invention, three dimensional orthogonal chart system 101 is utilized to chart stock transactions, with date being represented along the first (X) axis 110, and with price being plotted along the second (Y) axis 120 by ribbon 105 and volume being plotted along the third (Z) axis 125 by curtain 115. With respect to ribbon 105, it may also be shaded according to its variance from norm and its width may be fixed but represent the maximum volume traded. With respect to curtain 115, it may be shaded according to its variance from norm, and its opacity may vary in relation to its variance from norm.

Second Exemplary Illustration

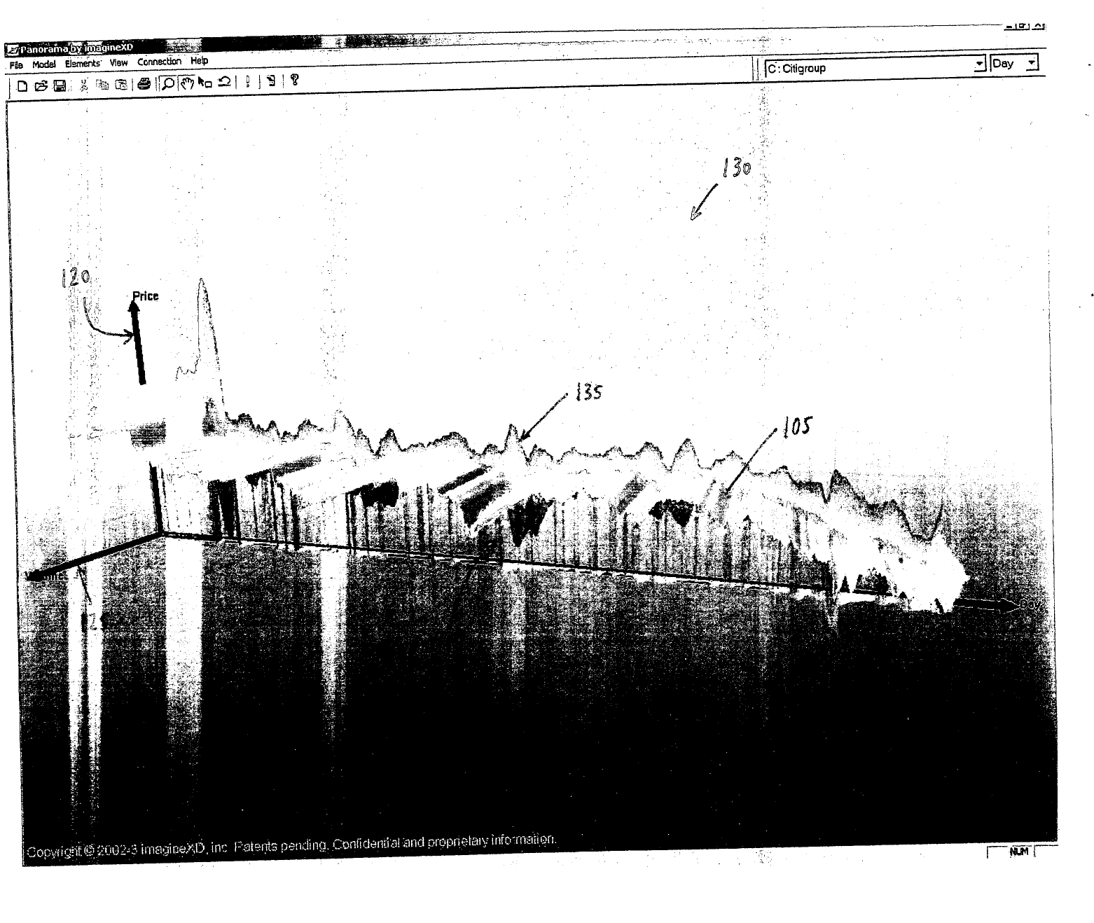

Looking next at FIG. 3, in another preferred exemplary illustration of the present invention, there is provided a three dimensional orthogonal chart system 130 for visualizing data comprising at least three data sets, wherein one data set is represented as a ribbon 105 propagating along the first (X) axis 110, the second data set is represented as a curtain 115 propagating along the first (X) axis 110, and the third data set is represented as a back plane 135 propagating along the first (X) axis 110. Again, ribbon 105 preferably varies in height along the second (Y) axis 120, while having a substantially fixed width as measured along the third axis (Z) axis 125. Preferably curtain 115 has a height along the second (Y) axis 120 which is the same as the height of ribbon 105 at that point along the first (X) axis 110, and a varying displacement along the third (Z) axis 125. Alternatively, curtain 115 may have a height different than the height of ribbon 105, e.g., it may be of a fixed height intersecting ribbon 105. Preferably back plane 135 varies in height along the second (Y) axis 120. If desired, ribbon 105, curtain 115 and back plane 135 can be colored and/or variably shaded and/or of varying opacity and/or of varying material properties (e.g., texture, reflectivity, shininess, etc.) so as to communicate additional information (i.e., data sets). In one particularly preferred form of the invention, three dimensional orthogonal chart system 101 is utilized to chart stock transactions, with date being represented along the first (X) axis 110, and with price being plotted along the second (Y) axis 120 by ribbon 105, volume being plotted along the third (Z) axis 125 by curtain 115, and standard deviation (i.e., σ) being plotted along the second (Y) axis 120 by back plane 135. With respect to ribbon 105, it may also be shaded according to its variance from norm and its width may be fixed but represent the maximum volume traded. With respect to curtain 115, it may be shaded according to its variance from norm, and its opacity may vary in relation to its variance from norm.

Third Exemplary Illustration

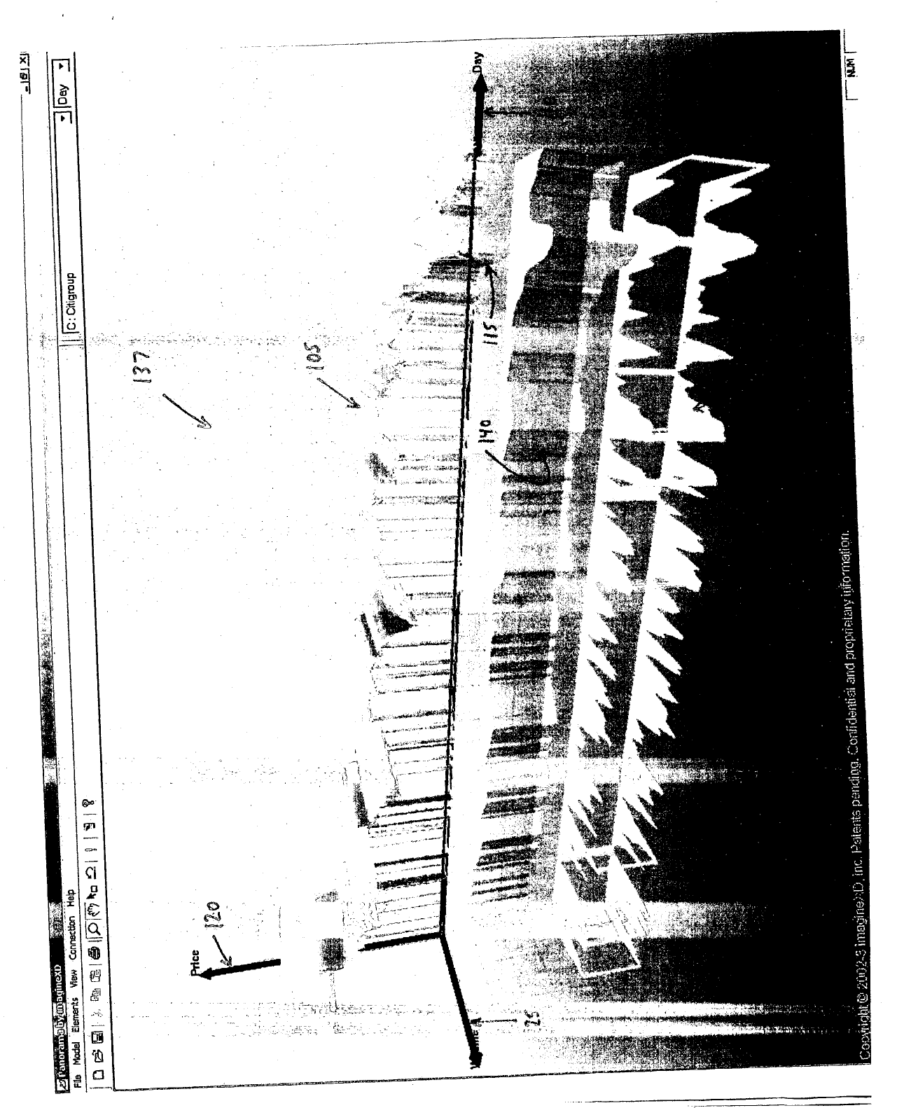

Looking next at FIG. 4, in another preferred illustration of the present invention, there is provided a three dimensional orthogonal chart system 137 for visualizing data comprising at least four data sets, wherein one data set is represented as a ribbon 105 propagating along the first (X) axis 110, the second data set is represented as a first curtain 115 propagating along the first (X) axis 110, and the third and fourth data sets are represented as stacked curtains 140 and 145, respectively, propagating along the first (X) axis 110. Again, ribbon 105 preferably varies in height along the second (Y) axis 120, while having a substantially fixed width as measured along the third (Z) axis 125. Preferably first curtain 115 has a height along the second (Y) axis 120 which is the same as the height of ribbon 105 at that point along the first (X) axis 110, and a varying displacement along the third (Z) axis 125. Alternatively, curtain 115 may have a height different than the height of ribbon 105, e.g., it may be of a fixed height intersecting ribbon 105. Preferably stacked curtains 140 and 145 have a substantially constant height along the second (Y) axis 120, and a varying displacement along the third (Z) axis 125. If desired, ribbon 105, first curtain 115 and stacked curtains 140 and 145 can be colored and/or variably shaded and/or of varying opacity and/or of varying material properties (e.g., texture, reflectivity, shininess, etc.) so as to communicate additional information (i.e., data sets). In one particularly preferred form of the invention, three dimensional orthogonal chart system 137 is utilized to chart stock transactions, with date being represented along the first (X) axis 110, and with price being plotted along the second (Y) axis 120 by ribbon 105, volume being plotted along the third (Z) axis 125 by curtain 115, moving average volume being plotted along the third (Z) axis 125 by stacked curtain 140 and stochastic (short term price velocity) being plotted along the third (Z) axis 125 by stacked curtain 145. With respect to ribbon 105, it may also be shaded according to its variance from norm and its width may be fixed but represent the maximum volume traded. With respect to curtain 115, it may be shaded according to its variance from norm, and its opacity may vary in relation to its variance from norm.

Fourth Exemplary Illustration

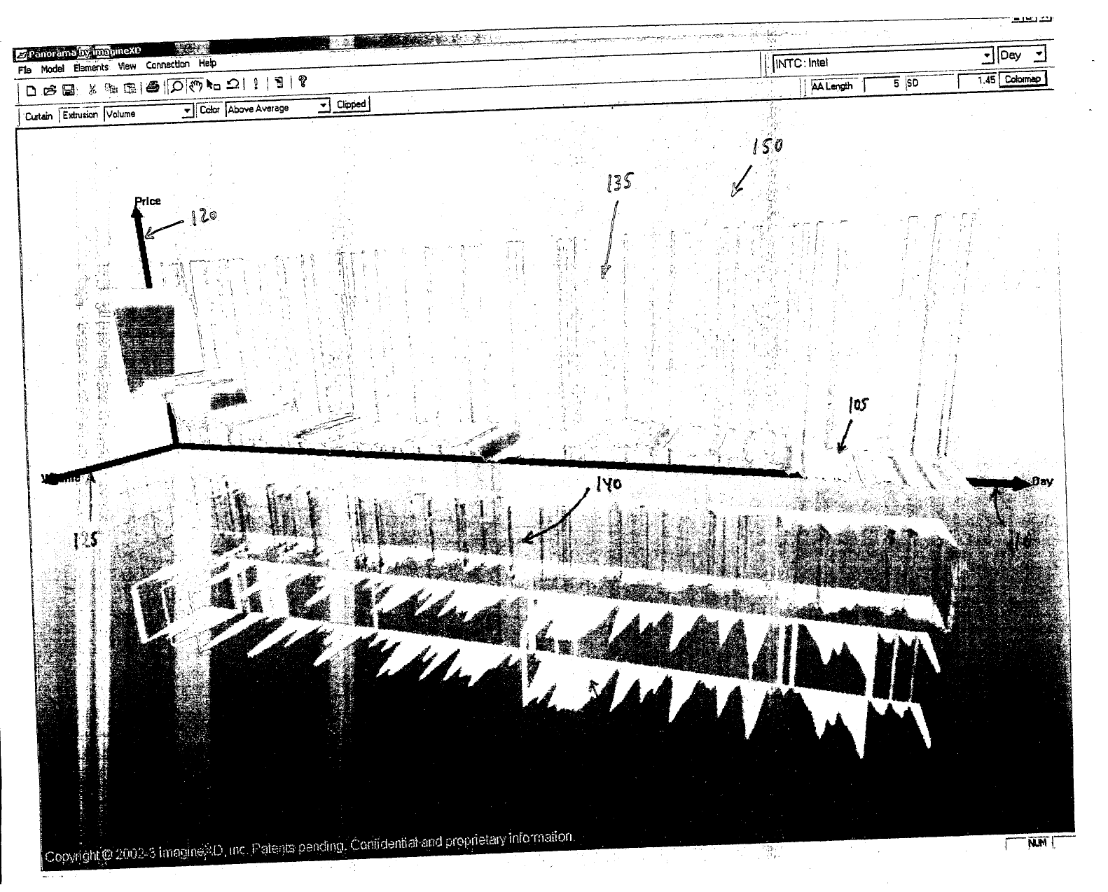

Looking next at FIG. 5, in another preferred exemplary illustration of the present invention, there is provided a three dimensional orthogonal chart system 150 for visualizing data comprising at least four data sets, wherein one data set is represented as a ribbon 105 propagating along the first (X) axis 110, the second and third data sets are represented as first and second stacked curtains 140 and 145, respectively, propagating along the first (X) axis 110, and the fourth data set is represented as a back plane 135 propagating along the first (X) axis 110, wherein the fourth data set comprises a composite of the second and third data sets. Alternatively, the fourth data set may comprise something other than a composite of the second and third data sets. Again, ribbon 105 preferably varies in height along the second (Y) axis 120, while having a substantially fixed width as measured along the third (Z) axis 125. Preferably stacked curtains 140 and 145 have a substantially constant height along the second (Y) axis 120, and a varying displacement along the third (Z) axis 125. If desired, ribbon 105 and stacked curtains 140 and 145 and back plane 135 can be colored and/or variably shaded and/or of varying opacity and/or of varying material properties (e.g., texture, reflectivity, shininess, etc.) so as to communicate additional information (i.e., data sets). In one particularly preferred form of the invention, three dimensional orthogonal chart system 150 is utilized to chart stock transactions, with date being represented along the first (X) axis 110, and with price being plotted along the second (Y) axis 120 by ribbon 105, stochastic (short term price velocity) being plotted along the third (Z) axis 125 by stacked curtain 140, volume being plotted along the third (Z) axis 125 by stacked curtain 145, and the composite of the stochastic and volume being plotted along the third (Z) axis 125 by back plane 135. With respect to ribbon 105, it may also be shaded according to its variance from norm and its width may be fixed but represent the maximum volume traded. With respect to stacked curtains 140 and 145, they may be shaded according to their variance from norm, and their opacity may vary in relation to their variance from norm.

Fifth Exemplary Illustration

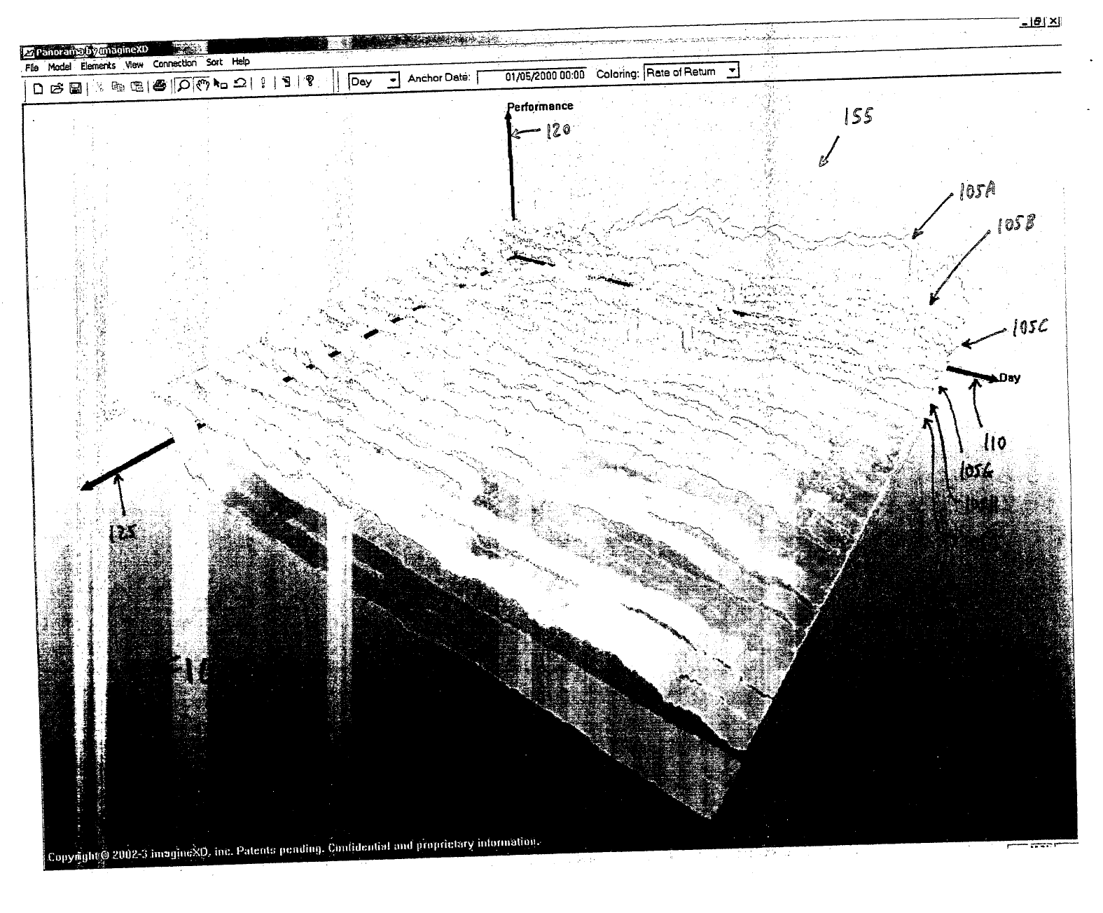

Looking next at FIG. 6, in another preferred exemplary illustration of the present invention, there is provided a three dimensional orthogonal chart system 155 for visualizing data comprising a plurality of data sets, wherein each of the data sets is represented as a separate ribbon 105A, 105B, 105C, etc. propagating along the first (X) axis 110, with the separate ribbons 105A, 105B, 105C, etc. being displaced from one another along the third (Z) axis 125. Each ribbon 105A, 105B, 105C, etc. preferably varies in height along the second (Y) axis 120, while having a substantially fixed width as measured along the third (Z) axis 125. If desired, ribbon 105A, 105B, 105C, etc. can be colored and/or variably shaded and/or of varying opacity and/or of varying material properties (e.g., texture, reflectivity, shininess, etc.) so as to communicate additional information (i.e., data sets). In one particularly preferred form of the invention, three dimensional orthogonal chart system 155 is utilized to chart stock transactions, with date being represented along the first (X) axis 110, and with the performance for one stock being plotted along the second (Y) axis 120 by ribbon 105A, the performance for another stock being plotted along the second (Y) axis 120 by ribbon 105B, the performance for still another stock being plotted along the second (Y) axis 120 by ribbon 105C, etc. By way of example but not limitation, performance can be measured in terms of rate of return, value, relative value, relative value over time, etc. With respect to ribbon 105A, 105B, 105C, etc, it may also be shaded according to its variance from norm and its width may be fixed but represent the maximum volume traded.

Sixth Exemplary Illustration

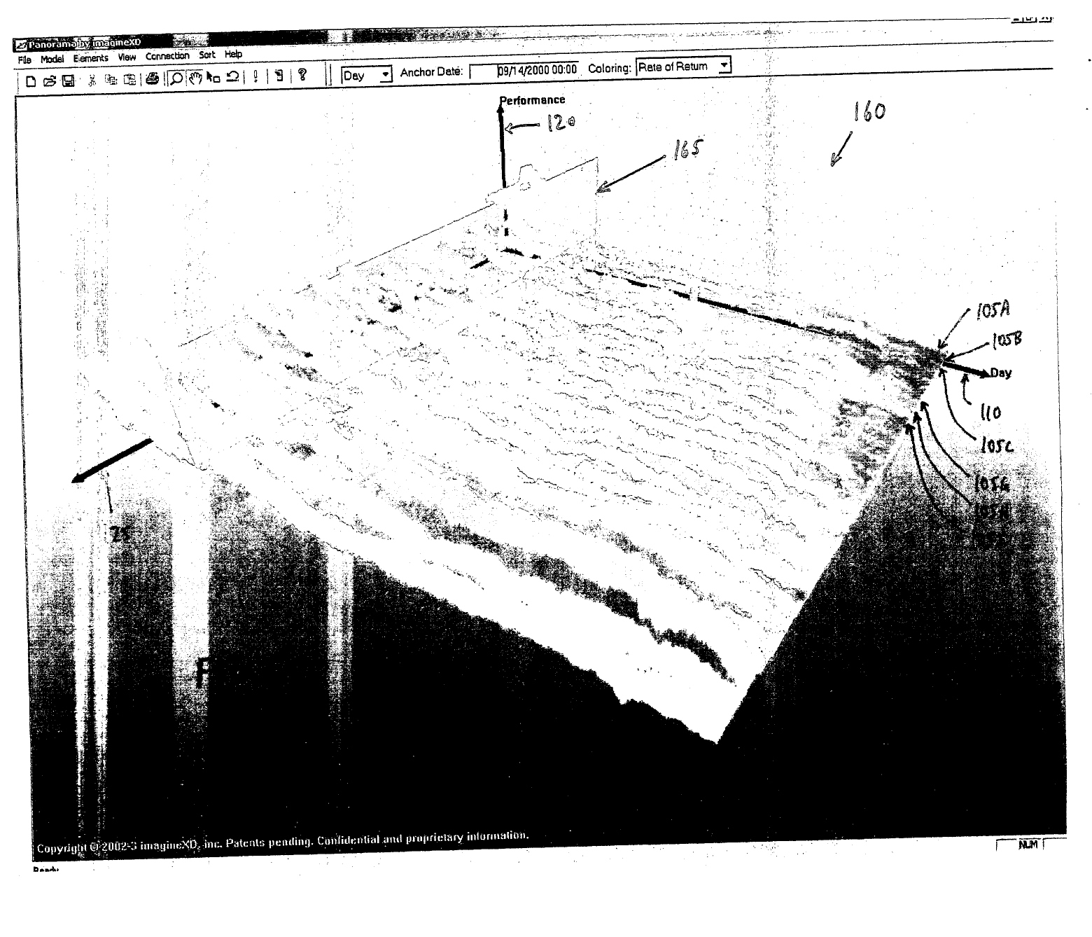

Looking next at FIG. 7, in another preferred exemplary illustration of the present invention, there is provided a three dimensional orthogonal chart system 160 for visualizing data comprising a plurality of data sets, wherein each of the data sets is represented as a separate ribbon 105A, 105B, 105C, etc. propagating along the first (X) axis 110, with the separate ribbons 105A, 105B, 105C, etc. being displaced from one another along the third (Z) axis 125, and a moving cursor plane 165 being configured for movement along the first (X) axis 110. Each ribbon 105A, 105B, 105C, etc. preferably varies in height along the second (Y) axis 120, while having a substantially fixed width as measured along the third (Z) axis 125. The moving cursor plane 165 preferably extends parallel to the second and third axes 120 and 125. If desired, ribbon 105A, 105B, 105C, etc. can be colored and/or variably shaded and/or of varying opacity and/or of varying material properties (e.g., texture, reflectivity, shininess, etc.) so as to communicate additional information (i.e., data sets). In one particularly preferred form of the invention, three dimensional orthogonal chart system 160 is utilized to chart stock transactions, with date being represented along the first (X) axis 110, and with the performance for one stock being plotted along the second (Y) axis 120 by ribbon 105A, the performance for another stock being plotted along the second (Y) axis 120 by ribbon 105B, the performance for still another stock being plotted along the second (Y) axis 120 by ribbon 105C, etc. Again, by way of example but not limitation, performance can be measured in terms of rate of return, value, relative value, relative value over time, etc. With respect to ribbon 105A, 105B, 105C, etc., it may also be shaded according to its variance from norm and its width may be fixed but represent the maximum volume traded.

Seventh Exemplary Illustration

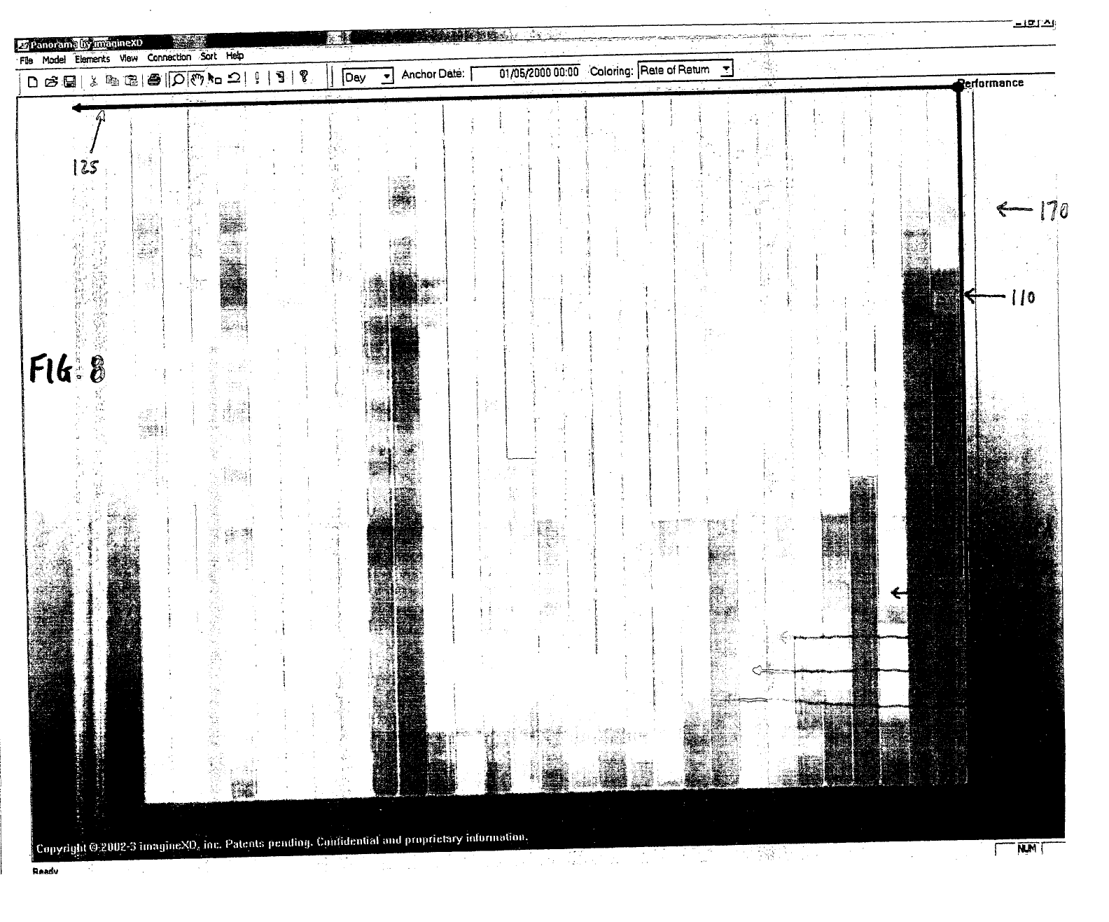

Looking next at FIG. 8, in another preferred exemplary illustration of the present invention, there is provided a three dimensional orthogonal chart system 170 for visualizing data comprising a plurality of data sets, wherein each of the data sets is represented as a separate ribbon 105A, 105B, 105C, etc. propagating along the first (X) axis 110, with the separate ribbons 105A, 105B, 105C, etc. being displaced from one another along the third (Z) axis 125, and with the angle of view being a overhead view in an orthographic projection. If desired, ribbon 105A, 105B, 105C, etc. can be colored and/or variably shaded and/or of varying opacity and/or of varying material properties (e.g., texture, reflectivity, shininess, etc.) so as to communicate additional information (i.e., data sets). In one particularly preferred form of the invention, three dimensional orthogonal chart system 170 is utilized to chart stock transactions, with date being represented along the first (X) axis 110, and with the performance for one stock being plotted along the second (Y) axis 120 by ribbon 105A, the performance for another stock being plotted along the second (Y) axis 120 by ribbon 105B, the performance for still another stock being plotted along the second (Y) axis 120 by ribbon 105C, etc. Again, by way of example but not limitation, performance can be measured in terms of rate of return, value, relative value, relative value over time, etc. With respect to ribbon 105A, 105B, 105C, etc., it may also be shaded according to its variance from norm and its width may be fixed but represent the maximum volume traded.

Eighth Exemplary Illustration

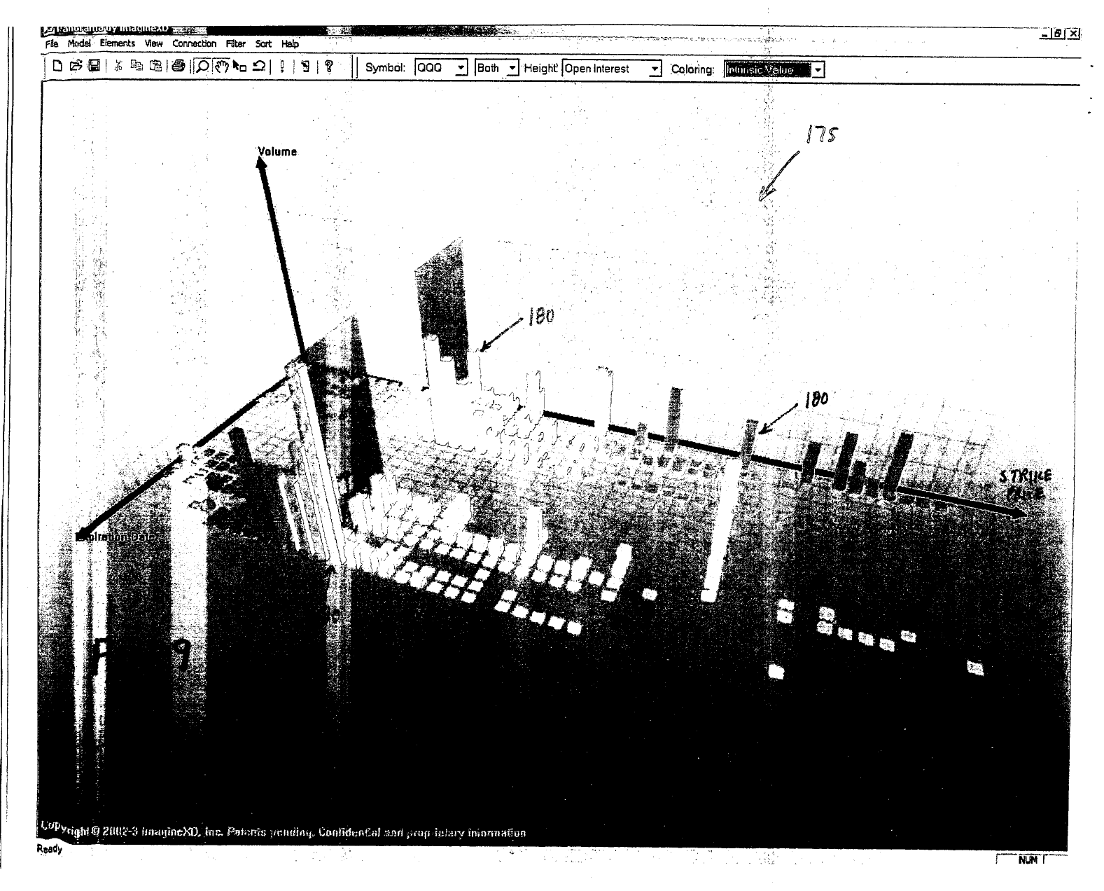

Looking next at FIG. 9, in another preferred exemplary illustration of the present invention, there is provided a three dimensional orthogonal chart system 175 for visualizing data comprising the pricing, distribution, and trading activity for option contracts, including both calls and puts. Individual option contracts may be represented by discrete objects 180 placed within the three dimensional chart system, where strike price may be plotted along the first (X) axis 110, volume (or some other data set) may be plotted along the second (Y) axis 120, and expiration date may be plotted along a third (Z) axis 125. Different shapes may represent different data sets, (e.g., calls may be represented by rectangles, puts by cylinders, etc.). Furthermore, color, shading, opacity, etc. may represent additional data sets. By way of example but not limitation, other data sets may comprise implied volatility, historical volatility, intrinsic value, time value, etc. The various axes may comprise discrete and finite elements, e.g., strike price may only occur at selected values.

Implementation

The present invention is preferably implemented with a computer system.

Computer Implementation—Overview. In a preferred computer implementation, the system is implemented in a software application running on a computer. The computer receives, collects and stores securities data which may be provided by one or more third-party, real-time data feeds, providing that data on both an as-requested and streamed basis to the computer.

Functional Components—The software is preferably divided into four functional components or stages: data receipt and collection, analysis, visualization, and interaction.

Data Collection—At this first stage, securities data is collected from one or more third-party data feed providers and stored. The computer obtains both historical and streamed data. In one preferred form of the invention, the computer can access both premium (i.e., for-payment access) and publicly available sources.

Analysis—In this second stage, a variety of user-selectable analytic methods may be applied to the data set. Existing financial analysis techniques (e.g., moving average, stochastic, etc.) are provided. Statistical elements derived in this stage are also available as data set inputs for the visualization stage. New technologies such as wavelet analysis for noise reduction are preferably also provided.

Visualization—In this third stage, the data sets are rendered in the manner previously described, using computer graphic techniques, so as to generate the aforementioned charts and thereby permit the user to more easily extract meaning from the data sets.

Interaction—In a preferred form of the invention, a sophisticated and intuitive user interface is provided, so as to enable the user to isolate, view, and compare a variety of different data sets. By way of example, the user interface permits the user to assign different data sets to different chart elements (e.g., price to ribbon, volume to curtain, etc.) and permits the user to move chart elements as appropriate (e.g., to move the moving cursor plane 160 shown in FIG. 7).

Applications

The present invention is particularly well suited for application to financial data. However, it will also be appreciated that it may be applied to a wide range of other fields as well, e.g., the analysis of scientific data, network traffic analysis, etc. The present invention is particularly well suited to time series analysis.

Modifications

It will, of course, be appreciated that various modifications may be made to the preferred embodiments described above without departing from the scope of the present invention.

Thus, for example, the elements of one embodiment may be combined with elements of another embodiment without departing from the present invention.

By way of example but not limitation, additional visual elements (e.g., additional ribbons, curtains, stacked curtains, back planes, etc.) may be added to any of the charts to represent additional data sets.

Furthermore, the angle of view may be altered or adjusted for any of the charts.

Also, if desired, charts may be generated via a variety of projections, e.g., perspective (as in the majority of the charts discussed above), orthographic, isometric, elevation, etc.

These and other changes of their type are considered to be within the scope of the present invention.

What is claimed is:

1. A data visualization system for visualizing data comprising at least one data set, wherein said data visualization system comprises:
user controls for permitting a user to supply instructions to the data visualization system;
a model database comprising a plurality of virtual three dimensional models; and
a processing engine adapted to receive user instructions provided through said user controls and, in accordance with those instructions, (1) select a virtual three dimensional model from the plurality of three dimensional models contained in said model database, (2) access the at least one data set, and (3) populate the selected virtual three dimensional model with the accessed at least one data set, whereby to generate a data structure comprising the selected virtual three dimensional model embodying a specific instance of the accessed at least one data set;
whereby said data structure can be used as an input to an image rendering engine so as to generate a two dimensional image for display to the user.

2. A system according to claim 1 wherein each of said virtual three dimensional models comprises at least one virtual three dimensional object having at least one attribute.

3. A system according to claim 2 wherein said at least one object comprises a ribbon.

4. A system according to claim 2 wherein said at least one object comprises a curtain.

5. A system according to claim 2 wherein said at least one object comprises a back plane.

6. A system according to claim 2 wherein said at least one object comprises a stacked curtain.

7. A system according to claim 2 wherein said at least one object comprises a moving cursor plane.

8. A system according to claim 2 wherein said at least one object comprises a rectangular block.

9. A system according to claim 2 wherein said at least one object comprises a cylinder.

10. A system according to claim 1 wherein each of said virtual three dimensional models comprises at least two objects arranged relative to one another in a three dimensional orthogonal coordinate system.

11. A system according to claim 10 wherein said at least two objects are chosen from the group consisting of a ribbon, a curtain, a back plane, a stacked curtain, a moving cursor plane, a rectangular block, and a cylinder.

12. A system according to claim 2 wherein said at least one attribute of an object comprises a physical property of the virtual three dimensional object.

13. A system according to claim 12 wherein said attribute comprises at least one property selected from the group comprising height, width, depth, color and opacity.

14. A system according to claim 12 wherein the populating of the at least one data set into the selected three dimensional model comprises assigning each of the at least one data sets to an attribute of an object.

15. A system according to claim 14 wherein said user controls and said processing engine are configured so that the assignment of a data set to an attribute of one object may be done independently of an assignment of a data set to an attribute to another object.

16. A system according to claim 1 wherein said user controls are exposed to the user on the basis of the model selected.

17. A system according to claim 16 wherein said user controls are configured to permit the selection of an object within a model, and further wherein the user controls are exposed to the user on the basis of the object selected.

18. A system according to claim 1 wherein said selected virtual three dimensional model comprises a polygonal surface model.

19. A system according to claim 1 wherein said system further comprises an image rendering engine, and further wherein said user controls are adapted to permit the user to supply instructions to said image rendering engine.

20. A system according to claim 1 wherein said system is adapted to work in real time, whereby said user may operate said user controls in a feedback mode so as to adjust the image displayed to the user.

21. A system according to claim 1 wherein said processing engine comprises application software running on a general purpose computer.

22. A system according to claim 1 wherein said user controls comprise human interface devices comprising at least one from the group consisting of a keyboard, a mouse, a touch screen display, a trackball, and voice recognition software.

23. A system according to claim 1 wherein said user controls comprise software controls comprising at least one from the group consisting of buttons, check boxes, menus, list boxes, text entry fields and dialogs.

24. A system according to claim 1 wherein said at least one data set comprises financial information.

25. A system according to claim 1 wherein said at least one data set comprises raw data obtained from the group consisting of a historical database, a live data feed, data derived from a historical database and data derived from a live data feed.

26. A system according to claim 1 wherein said at least one data set comprises price, volume, yield, relative compound growth, relative portfolio value, and/or other relevant metrics relating to securities and other financial instruments such as, but not limited to, stocks, bonds, mutual funds, options, futures, indexes, derivatives, currency, Treasuries, money market funds, and the like.

27. A system according to claim 1 wherein said at least one virtual three dimensional model comprises at least two virtual three dimensional objects, wherein one object comprises a ribbon propagating along a first axis, and the second object comprises a curtain propagating along the first axis.

28. A system according to claim 1 wherein said at least one virtual three dimensional model comprises at least three virtual three dimensional objects, wherein one object comprises a ribbon propagating along a first axis, the second object comprises a curtain propagating along the first axis, and the third object comprises a back plane propagating along the first axis.

29. A system according to claim 1 wherein said at least one virtual three dimensional model comprises at least three virtual three dimensional objects, wherein one object comprises a ribbon propagating along a first axis, the second object comprises a first curtain propagating along the first axis, and the third object comprises a stacked curtain propagating along the first axis.

30. A system according to claim 1 wherein said at least one virtual three dimensional model comprises at least four virtual three dimensional objects, wherein one object comprises a ribbon propagating along a first axis, the second and third objects comprise first and second stacked curtains, respectively, propagating along the first axis, and the fourth object comprises a back plane propagating along the first axis.

31. A system according to claim 1 wherein said at least one virtual three dimensional model comprises a plurality of virtual three dimensional objects, wherein at least some of said objects comprise a separate ribbon propagating along a first axis, with the separate ribbons being displaced from one another along another axis.

32. A system according to claim 1 wherein said at least one virtual three dimensional model comprises a plurality of virtual three dimensional objects, wherein at least some of said objects comprise a separate ribbon propagating along a first axis, with the separate ribbons being displaced from one another along another axis, and wherein another of said objects comprises a moving cursor plane being configured for movement along the first axis.

33. A system according to claim 1 wherein said at least one virtual three dimensional model comprises a plurality of virtual three dimensional objects, wherein at least some of the objects comprise a separate ribbon propagating along a first axis, with the separate ribbons being displaced from one another along another axis, and with the angle of view being an overhead view in an orthographic projection.

34. A system according to claim 1 wherein said at least one virtual three dimensional model comprises a plurality of virtual three dimensional objects placed within a three dimensional chart system, where strike price may be plotted along the first axis, option price (or some other data set) may be plotted along the second axis, and expiration date may be plotted along a third axis.

35. A system according to claim 1 wherein said at least one data set is dynamic in nature, and further wherein said processing engine is configured to respond to changes in said at least one data set by regenerating said data structure.

36. A system according to claim 1 wherein said processing engine is configured to monitor said at least one data set and to respond to changes in said at least one data set by regenerating said data structure.

37. A system according to claim 35 wherein said processing engine is configured to periodically re-access said at least one data set and automatically regenerate said data structure.

38. A system according to claim 1 wherein said at least one data set is a source data set and further wherein said processing engine is adapted to derive at least one additional data set from said at least one source data set.

39. A system according to claim 38 wherein said processing engine is configured to provide a suite of processing functions for generating said at least one derived data set and further wherein said user controls enable the user to select specific processing functions, and parameters relating thereto, whereby to generate the desired at least one derived data set.

40. A method for visualizing data comprising at least one data set, wherein said method comprises:
selecting a virtual three dimensional model from a plurality of three dimensional models contained in a model database;
accessing the at least one data set;
populating the selected virtual three dimensional model with the accessed at least one data set, whereby to generate a data structure comprising the selected virtual three dimensional model embodying a specific instance of the accessed at least one data set; and
inputting said data structure to an image rendering engine so as to generate a two dimensional image for display to the user.

41. A method according to claim 40 wherein each of said virtual three dimensional models contained in the model database comprises at least one virtual three dimensional object having at least one attribute.

42. A method according to claim 41 wherein said at least one object comprises a ribbon.

43. A method according to claim 41 wherein said at least one object comprises a curtain.

44. A method according to claim 41 wherein said at least one object comprises a back plane.

45. A method according to claim 41 wherein said at least one object comprises a stacked curtain.

46. A method according to claim 41 wherein said at least one object comprises a moving cursor plane.

47. A method according to claim 41 wherein said at least one object comprises a rectangular block.

48. A method according to claim 41 wherein said at least one object comprises a cylinder.

49. A method according to claim 40 wherein each of said virtual three dimensional models comprises at least two objects arranged relative to one another in a three dimensional orthogonal coordinate system.

50. A method according to claim 49 wherein said at least two objects are chosen from the group consisting of a ribbon, a curtain, a back plane, a stacked curtain, a moving cursor plane, a rectangular block, and a cylinder.

51. A method according to claim 41 wherein said at least one attribute of an object comprises a physical property of the virtual three dimensional object.

52. A method according to claim 51 wherein said attribute comprises at least one property selected from the group comprising height, width, depth, color and opacity.

53. A method according to claim 51 wherein the populating of the at least one data set into the selected three dimensional model comprises assigning each of the at least one data sets to an attribute of an object.

54. A method according to claim 53 wherein the assignment of a data set to an attribute of one object is done independently of an assignment of a data set to an attribute to another object.

55. A method according to claim 40 wherein said selected virtual three dimensional model comprises a polygonal surface model.

56. A method according to claim 40 wherein said method further comprises supplying instructions to the image rendering engine.

57. A method according to claim 40 wherein said method further comprises viewing the image displayed to the user and thereafter repeating at least one of the selecting, accessing and/or populating steps so as to adjust the image displayed to the user.

58. A method according to claim 40 wherein said at least one data set comprises financial information.

59. A method according to claim 40 wherein said at least one data set comprises raw data obtained from the group consisting of a historical database, a live data feed, data derived from a historical database and data derived from a live data feed.

60. A method according to claim 40 wherein said at least one data set comprises price, volume, yield, relative compound growth, relative portfolio value, and/or other relevant metrics relating to securities and other financial instruments such as, but not limited to, stocks, bonds, mutual funds, options, futures, indexes, derivatives, currency, Treasuries, money market funds, and the like.

61. A method according to claim 40 wherein said at least one virtual three dimensional model comprises at least two virtual three dimensional objects, wherein one object comprises a ribbon propagating along a first axis, and the second object comprises a curtain propagating along the first axis.

62. A method according to claim 40 wherein said at least one virtual three dimensional model comprises at least three virtual three dimensional objects, wherein one object comprises a ribbon propagating along a first axis, the second object comprises a curtain propagating along the first axis, and the third object comprises a back plane propagating along the first axis.

63. A method according to claim 40 wherein said at least one virtual three dimensional model comprises at least three virtual three dimensional objects, wherein one object comprises a ribbon propagating along a first axis, the second object comprises a first curtain propagating along the first axis, and the third object comprises a stacked curtain propagating along the first axis.

64. A method according to claim 40 wherein said at least one virtual three dimensional model comprises at least four virtual three dimensional objects, wherein one object comprises a ribbon propagating along a first axis, the second and third objects comprise first and second stacked curtains, respectively, propagating along the first axis, and the fourth object comprises a back plane propagating along the first axis.

65. A method according to claim 40 wherein said at least one virtual three dimensional model comprises a plurality of virtual three dimensional objects, wherein at least some of said objects comprise a separate ribbon propagating along a first axis, with the separate ribbons being displaced from one another along another axis.

66. A method according to claim 40 wherein said at least one virtual three dimensional model comprises a plurality of virtual three dimensional objects, wherein at least some of said objects comprise a separate ribbon propagating along a first axis, with the separate ribbons being displaced from one another along another axis, and wherein another of said objects comprises a moving cursor plane being configured for movement along the first axis.

67. A method according to claim 40 wherein said at least one virtual three dimensional model comprises a plurality of virtual three dimensional objects, wherein at least some of the objects comprise a separate ribbon propagating along a first axis, with the separate ribbons being displaced from one another along another axis, and with the angle of view being an overhead view in an orthographic projection.

68. A method according to claim 40 wherein said at least one virtual three dimensional model comprises a plurality of virtual three dimensional objects placed within a three dimensional chart system, where strike price may be plotted along the first axis, option price (or some other data set) may be plotted along the second axis, and expiration date may be plotted along a third axis.

69. A method according to claim 40 wherein said at least one data set is dynamic in nature, and further wherein changes in said at least one data set are accommodated by regenerating said data structure.

70. A method according to claim 40 wherein said at least one data set is monitored and changes in said at least one data set are accommodated by regenerating said data structure.

71. A method according to claim 40 wherein said at least one data set is periodically re-accessed and said data structure is regenerated.

72. A method according to claim 40 wherein said at least one data set is a source data set and further wherein at least one additional data set is derived from said at least one source data set.
